(19) United States
(12) Patent Application Publication
(10) Pub. No.: US 2010/0096792 A1
(43) Pub. Date: Apr. 22, 2010

(54) Clamping Device

(76) Inventor: Ludwig Demmeler, Heimertingen (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/581,667

(22) Filed: Oct. 19, 2009

(30) Foreign Application Priority Data
Oct. 20, 2008 (DE) 102008052159.0
Mar. 11, 2009 (DE) 102009012301.6

(51) Int. Cl. B25B 5/06; B25B 5/16

(52) U.S. Cl. 269/216; 269/287

(57) ABSTRACT

The invention relates to a clamping device, in particular for clamping a workpiece, comprising a support body 10 including a clamping member 20 for applying an axial force at a longitudinal end thereof and a limiting member 30 substantially in the region of the opposite longitudinal end of the support body 10, and at least one expansion region 40, 50. In this arrangement, a ball clamping set 60, 70 is arranged in each case in the at least one expansion region 40, 50, the at least one ball clamping set 60, 70 including at least one first ball 80 having a first diameter and at least two second balls 90, 95 having a second diameter, the first diameter being larger than the second diameter and the at least one ball clamping set 60, 70 cooperating with the clamping member 20. In addition, the balls 80, 90, 95 of the ball clamping set 60, 70 are in contact so as to convert the axial force of the clamping member 20 by means of the ball clamping set 60, 70 into a radial force which acts towards the support body 10.

### TECHNICAL FIELD

The present invention relates to a clamping device, in particular for clamping a workpiece, which enables to clamp and release with a reduced force. The clamping device also allows a cost-effective production on account of its simplified design.

### BACKGROUND

The prior art discloses a plurality of clamping devices. Here, different principles regarding the provision of the clamping force are applied depending on the intended use, the available mounting space or the amount of the required clamping force.

For example, if high clamping forces are to be provided, hydraulic clamping devices are often used where a pressurized active medium acts on a device converting the hydrostatic pressure of the active medium into a preferably radial, or radial and axial, clamping force. However, these clamping devices have to be fed with the compressed active medium and their components in contact with the active medium have to be sealed extensively so that such clamping devices have rather large dimensions and their production is expensive. After a clamping pressure decrease, hydraulic clamping devices are also unable to release the tool or workpiece again and therefore need a further device for returning the tool or workpiece, thus further raising the costs for the clamping device.

Mechanical clamping devices which convert the required clamping force by frictional and/or positive connections of several components are cost-effective alternatives. For example, DE 36 03 301 C2 shows a clamping device for workpieces or tools, which converts an axial force applied by means of a clamp screw into a radial clamping force via two inversely arranged cone-shaped components. The disadvantages of this clamping device are the great force required for releasing the clamped workpiece and for removing the workpiece as well as a highly limited conversion of the applied axial force into a radial (clamping) force which results from the active principle of cone clamping. Furthermore, a rather large adjustment distance is required at the clamp screw until the desired clamping force has been achieved so that the screw only abuts against the workpiece after a delay.

### SUMMARY OF THE INVENTION

It is an object of the present invention to provide a clamping device which enables both the clamping and releasing of a component using small forces and simultaneously has a compact configuration and which includes a simple design so that it is possible to produce the clamping device in cost-effective manner.

According to the invention, a clamping device is provided which has a support body that may have a clamping member for applying an axial force at a longitudinal end thereof and a limiting member substantially in the region of the opposite longitudinal end of the support body. Moreover, the clamping device may comprise at least one expansion region. In addition, a ball clamping set can be arranged in the at least one expansion region in each case, wherein the at least one ball clamping set can include at least one first ball having a first diameter and at least two second balls having a second diameter, the first diameter being larger than the second diameter. In addition, the at least one ball clamping set can cooperate with the clamping member, and the balls of the ball clamping set can be in contact so as to convert the axial force of the clamping member by means of the ball clamping set into a radial force which acts towards the support body.

The advantage of this clamping device design according to the invention is that it enables to realize a very efficient conversion of an axial force into a radial force, or also into an axial force and a radial force, since the conversion is effected by means of balls in which substantially no frictional forces occur on account of the point-to-point contact situation relative to one another and to the support body.

Moreover, the applied axial force can again be reversibly reduced after the release by the clamping device according to the invention so that as compared to the known principle of clamping by means of wedges the separation force is now very small and the formerly clamped workpiece can directly be removed again by the user without the use of a returning device. The radial force, or the radial force and the axial force, in the clamping device are reduced over a very short distance by screwing the clamping member out of the sleeve, for example, so as to eliminate the regular arrangement of the balls of the ball clamping set and reduce the number of the points of contact of the balls with the interior wall of the sleeve.

Furthermore, the clamping device can realize the conversion of the forces or the build-up of the forces by means of the ball clamping set over a very short distance so as to obtain a very steep force characteristic via the screw-in path and to apply the desired clamping force in a radial direction in a very short time when the clamping member is actuated, which, as described above, also results in a very rapid reduction of the clamping forces during releasing.

The clamping device according to the invention can also realize an application-specific conversion of the applied axial force by means of a suitable selection of the diameters of the balls in the ball clamping set. For example, the clamping device can provide e.g. high radial forces along the lines of a reduction by means of second balls having a small diameter while the first balls have a large diameter.

The use of, preferably hardened, balls as a means of force conversion and force deflection also permits a very cost-effective arrangement of the ball clamping set according to the invention and thus of the entire clamping device. Furthermore, the clamping device may have a very compact design since an effective conversion of the forces is already possible with a very small number of balls and correspondingly a shorter length of the ball clamping set.

A ball is not only understood to mean balls having a rotationally symmetric shape but this term is also intended to comprise ball segments or ball-like arrangements, e.g. along the lines of an ellipsoid, along the lines of an elliptic paraboloid or a hyperbolic cone or even cone-shaped arrangements.

The support body can preferably be a sleeve. As a result, the clamping device can be used e.g. in connection with a work table and a welding bench for the spatial support of workpieces, the work table being able to support the sleeve via a plurality of bores on its surface.

Furthermore, the support body of a clamping device can have at least two slot-like recesses at its outer circumferential region, the interior region of the at least two slot-like recesses forming a clamping tongue each. As a result, the clamping tongues can move outwards under a radial load so as to establish a contact with the workpiece to be clamped and apply the clamping force to the workpiece.

In a clamping device, the support body and the clamping tongues can preferably have a one-part design. For example, this allows the clamping device to be produced from a sleeve as a basic body, the introduction of slots into the outer circumferential region of the sleeve serving for forming the clamping tongues. Thus, the sleeve and the clamping tongues both have the same curvature so as to transmit the radial force to the workpiece to be clamped in the circumferential direction in a particularly uniform way.

In a preferred embodiment of the clamping device, the support body can have at least one undercut structuring in the region of at least one clamping tongue. This undercut structuring prevents in a particularly advantageous way the lift-off of the clamping tongues from the sleeve under radial load, which might otherwise cause the loaded balls of the ball clamping set to escape from the sleeve interior. In addition, the undercut structuring of the interface between clamping tongue and sleeve permits an axial compensation of the clamping tongue to be realized during bulging under radial forces so as to reduce the load of the clamping force in the region of this interface.

Moreover, a movement of a longitudinal end of at least one clamping tongue can be limited in a clamping device according to the invention by the undercut structuring of the support body in the region of at least one clamping tongue.

In a clamping device, the clamping member can preferably be a first bush having a screw thread for screw fitting in the sleeve having a correspondingly designed internal screw thread. This design permits a particularly cost-effective production of the clamping device. In addition, the axial force can be applied in a very simple way by the user, the accessibility not being limited during the application.

The clamping tongues can be arranged so as to form at least two opposite clamping tongues which are mirror-inverted relative to a point with respect to each other. The reflection point is located on the rotary axis of the sleeve when a sleeve is used as the support body.

In addition, the limiting member may be movable in a clamping device. As a result, a clamping force can additionally be applied to a further workpiece in the axial direction by the clamping device so as to further add to the value of the clamping device.

The limiting member of a clamping device can preferably be a second bush having a screw thread for screw fitting in the support body.

In a preferred embodiment, the clamping device can be a power amplifier. As mentioned above, the radial forces can be chosen in the clamping device according to the invention by selecting the diameters of the second and first balls of the ball clamping set so as to obtain a power amplification of the radial force on the support body.

In addition, the bending stiffness of the support body can be increased in the clamped state with respect to the unclamped state in a clamping device according to the invention. If the support body is exposed to an axial tensile load during clamping, this results in a stiffening of the support body so that the clamping device can receive greater bending moments with equal deformation. As a result, a clamped workpiece can be retained in the desired position with greater accuracy.

The at least two slot-like recesses can preferably be directed in the radial direction towards the center axis of the sleeve in a clamping device.

Also, adjoining expansion regions can be interconnected by means of at least one bridging member in a clamping device. In this arrangement, the bridging member can preferably be a movable cylinder.

In a preferred embodiment of the clamping device, a bush for receiving a workpiece can be disposed at a longitudinal end of the sleeve. Here, the bush for receiving the workpiece can be mounted non-pivotably or pivotably on the support body or the sleeve.

In addition, the at least two slot-like recesses can be produced by means of laser machining in the clamping device. In a further embodiment, the slot-like recesses can also be introduced into the support body by means of jet cutting.

A longitudinal end of at least one clamping tongue of the clamping device can preferably realize the function of a hinge. This allows the clamping tongue to form, under load, a bulge in the region of the interconnection with the support body, a longitudinal compensation of the clamping tongue being simultaneously possible so as to reduce the load. This inventive structuring of the interface between support body and clamping tongue can thus have the effect of a spring member.

In addition, at least one clamping tongue of a clamping device can have a curved design. This permits a particularly advantageous abutment of the clamping tongue against the workpiece to be clamped while it is simultaneously possible to realize a particularly uniform application of force in the radial direction.

In a preferred embodiment of the clamping device, at least one clamping tongue can be formed by a single slot.

The support body and the clamping tongues of the clamping device can preferably be made of the same material. This permits a particularly cost-effective production of the clamping device since a tube can thus be used as a basic body for the support body, the clamping tongues being preferably made therein by means of laser cutting.

In addition, the at least one ball clamping set can cooperate with a force transmission member in a clamping device according to the invention, the force transmission member being movably supported in the support body. The force transmission member can be designed along the lines of a slider, for example, said slider being adapted to form a positive connection with a body when it is moved.

According to the invention, a device for converting a longitudinal force into a lateral force is provided, comprising a support body including a clamping member for applying the longitudinal force and a limiting member. In this arrangement, at least one ball clamping set can be disposed between the clamping member and the limiting member, the at least one ball clamping set including at least one first spherical surface having a first diameter and at least two second balls having a second diameter, the first diameter being larger than the second diameter and the at least one ball clamping set being adapted to cooperate with the clamping member. In addition, the balls of the ball clamping set may be in contact so as to convert by means of the ball clamping set the longitudinal force of the clamping member into the lateral force acting towards the support body.

The terms longitudinal and lateral are not limited to the geometrical lengths and the orientation or the extension of the particular bodies or corresponding regions of the device. These expressions rather also comprise the directions and orientations which are substantially perpendicular to one another and in which a force applied in a first direction is converted into at least one further direction by means of the at least one ball clamping set according to the invention, the latter direction being substantially perpendicular to the first direction.

Moreover, a clamping region, in particular for interconnection with a bush, can be formed in a clamping device according to the invention and has at least two clamping ball supports which fully extend through the wall of the support body and contain at least one clamping ball each, the at least one clamping ball moving along the accompanying clamping ball support. In addition, the clamping balls can cooperate with the at least one ball clamping set such that they are in contact with the at least one ball clamping set and the clamping balls are confined in an end position by the accompanying clamping ball support and protrude up to a predetermined height from the surface of the support body.

A further aspect of the invention relates to the use of the device for converting a longitudinal force into a lateral force to actuate brake shoes, the clamping member being an actuator.

### BRIEF DESCRIPTION OF THE DRAWINGS

Non-limiting and non-exhaustive embodiments of the present invention are described below with reference to the following figures, wherein like reference numerals refer to like parts throughout the various views unless otherwise specified.

FIG. 1 shows a lateral view of a clamping device according to the present invention.

FIG. 2 shows a rear view of the clamping device according to FIG. 1.

FIG. 3 shows a sectional view of the clamping device according to FIG. 1 along section line A-A.

FIG. 4 shows a sectional view of the clamping device according to FIG. 1 along section line B-B.

FIG. 5 shows a sectional view of the clamping device according to FIG. 1 along section line C-C.

FIG. 6 shows an enlarged sectional view of the clamping device according to FIG. 1 in the region Z of FIG. 3.

FIG. 7 shows a partial sectional view of the clamping device according to FIG. 1.

FIG. 8 shows a partial sectional view of a second embodiment of the clamping device according to the invention.

FIG. 9 shows a partial sectional view of a third embodiment of the clamping device according to the invention.

FIG. 10 shows a lateral view of a fourth embodiment of the clamping device according to the present invention.

FIG. 11 shows a partial sectional view of the clamping device according to FIG. 10 along section line D-D and a sectional view along section line E-E.

FIG. 12 shows a rear view of the clamping device according to FIG. 10.

FIG. 13 shows a lateral view of a fifth embodiment of the clamping device according to the present invention.

FIG. 14 shows a rear view of the clamping device according to FIG. 13.

FIG. 15 shows an enlarged partial sectional view of the clamping device according to FIG. 13 along section line F-F with a limiting member in a starting position.

FIG. 16 shows an enlarged partial sectional view of the clamping device according to FIG. 13 along section line F-F with the limiting member in an extended position.

FIG. 17 shows a lateral view of a sixth embodiment of the clamping device according to the present invention.

FIG. 18 shows a sectional view of the sixth embodiment of the clamping device according to FIG. 17 of the invention along section line G-G.

FIG. 19 shows an enlarged sectional view of the region Z of the clamping device according to FIG. 18 of the invention.

FIG. 20 shows a perspective view of the clamping device according to FIG. 17.

FIG. 21 shows a lateral view of a seventh embodiment of the clamping device according to the present invention.

FIG. 22 shows a perspective view of the clamping device according to FIG. 21.

FIG. 23 shows a lateral view of an eighth embodiment of the clamping device having a clamping mechanism for a bush according to the present invention.

FIG. 24 shows a further lateral view of the clamping device according to FIG. 23.

FIG. 25 shows a perspective view of the clamping device according to FIG. 23.

FIG. 26 shows a lateral sectional view of a multi-interface bush for clamping at the clamping device according to FIG. 23.

FIG. 27 shows a perspective view of the multi-interface bush for clamping according to FIG. 26.

### DETAILED DESCRIPTION OF THE ILLUSTRATED EMBODIMENTS

Embodiments of an apparatus, system and method for a clamping device are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

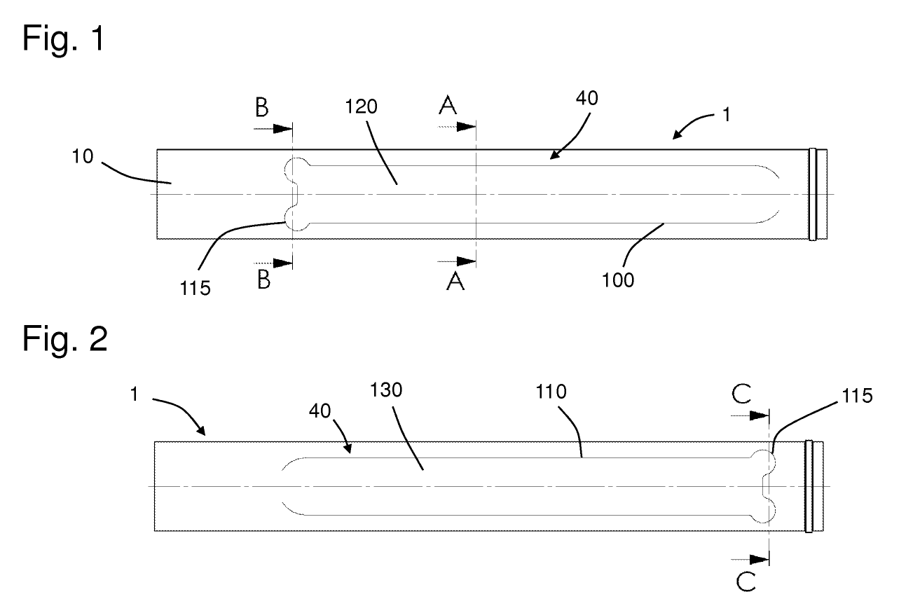

With reference to FIG. 1 and FIG. 2, a diagram of a clamping device 1 is shown in accordance with the present invention, in particular for use on a work table for clamping workpieces. The clamping device 1 has a cylindrical housing in the form of a sleeve 10, the outside diameter of the sleeve 10 being substantially 28 mm and the inside diameter being substantially 20 mm. The sleeve 10 consists of a metallic material, e.g. a steel alloy, but can also be made from a composite material.

An expansion region 40, to which when an axial force is applied a radial force is applied which in turn expands the outer circumference region of the sleeve 10 and of clamping tongues 120, 130, extends from the central region of the sleeve 10 towards the longitudinal ends of the sleeve 10. The expansion region 40 extends from the central region of the sleeve 10, along the longitudinal direction thereof, substantially to one longitudinal end of the sleeve 10 and in the opposite direction substantially to half the length of the sleeve 10.

The clamping tongues 120, 130 are limited by slots 100, 110 which were introduced into the wall of the sleeve 10 by means of laser machining. The thickness of the slots 100, 110 is substantially 2/10 mm. The slots 100, 110 extend substantially parallel to the rotary axis of the sleeve 10, the design being curved at a longitudinal end of the clamping tongue 120, 130 in each case with respect to the rotary axis of sleeve 10. The clamping tongues 120, 130 and the sleeve 10 are in each case interconnected in this region by means of a bridge which realizes the function of a hinge and of a spring member for the axial longitudinal compensation under load. Furthermore, the curved design of the slots 100, 110 in the described region enables to prevent, under load, the formation of cracks and—as a result therefrom—a growth of cracks in the slots 100, 110 into the region of the bridge or into the region outside the clamping tongues 120, 130.

In the region of the other longitudinal end of the clamping tongues 120, 130, one undercut region 115 each is formed in the sleeve 10 by the slots 100, 110, said region receiving a correspondingly designed counterpart of the clamping tongue 120, 130 so that a removal of the clamping tongue 120, 130 from the region 115 is not possible under load while the region of the clamping tongue 120, 130 can move outwards in the radial direction.

The two clamping tongues 120, 130 are arranged on opposite sides, the geometries of the clamping tongues 120, 130 being oriented so as to be mirror-inverted relative to a point with respect to each other. The accompanying reflection point is located on the rotary axis of the sleeve 10 and in the central region of the clamping tongue 120, 130. In addition, the outlines of the individual slots 100, 110 and the individual clamping tongues 120, 130 are mirror-symmetric relative to a plane which extends through the rotary axis of sleeve 10.

The clamping tongues 120, 130 and the sleeve 10 are made of the same material. Moreover, the clamping tongues 120, 130 and the sleeve 10 have a one-part design.

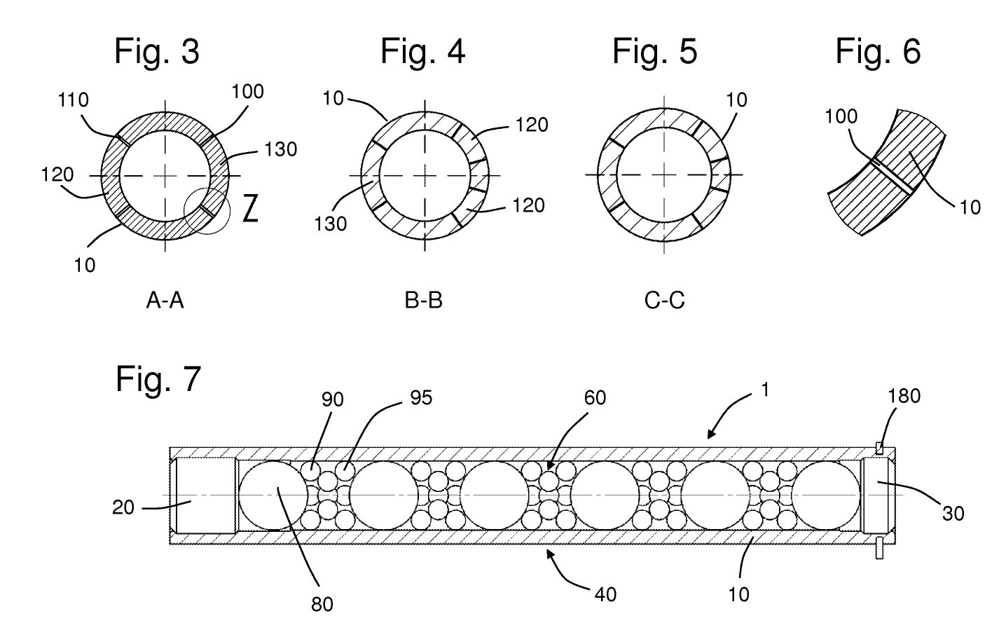

The extension of the slots 100, 110 over the cross-section of the sleeve 10 is now described with reference to FIGS. 3-6. In the sectional views of FIGS. 3-6, the ball clamping sets are not shown for reasons of comprehensibility. The sectional view according to FIG. 3 along section line A-A shows the wall of sleeve 10 which is perforated by slots 100, 110 such that two opposite regions of the clamping tongues 120, 130 form and can be moved outwards when a radial force is applied. The extension of the slots 100, 110 over the wall of sleeve 10 is directed to the rotary axis of sleeve 10, the slots 100, 110 fully penetrating the wall in each case. The curvature of the sleeve 10 is identical with the curvature of the clamping tongues 120, 130.

FIG. 4 shows the different cross-sectional segments of the clamping tongues 120, 130 and the sleeve 10 as formed in the area of the undercut region 115 in sleeve 10 along section line B-B according to FIG. 1. The extension of the slots 100, 110 over the wall of sleeve 10 is also directed to the rotary axis of sleeve 10, each of the slots 100, 110 fully penetrating the wall.

FIG. 5 shows the different cross-sectional segments of the clamping tongues 120, 130 and the sleeve 100, as formed along section line C-C according to FIG. 1. The above explanations on the extension of slots 100, 110 apply correspondingly.

FIG. 6 shows an enlarged sectional view of the region Z according to FIG. 3 and illustrates the radial extension of slot 100 along the wall of sleeve 10.

The partial sectional view according to FIG. 7 shows the design of the clamping device of FIG. 1 according to the invention with a ball clamping set 60 arranged in the interior of sleeve 10. A bush 20 is arranged at a longitudinal end of sleeve 10 and can be screw fitted with the inner wall of sleeve 10 by means of a screw thread. The longitudinal end of bush 20 which faces the interior of sleeve 10 is designed along the lines of a plane surface which is perpendicular to the rotary axis of sleeve 10. A plug 30 is arranged at the longitudinal end, opposite the bush 20, of sleeve 10 and is non-movably mounted in the inner wall of sleeve 10. The longitudinal end of plug 30 which faces the interior of sleeve 10 is also designed like a plane surface which is perpendicular to the rotary axis of sleeve 10. In order to limit the screw-in depth of the bush 20, it is also possible to provide a snap ring (not shown) or a Seeger ring (not shown) on the inner wall of sleeve 10.

In the region of the longitudinal end, opposite the bush 20, of sleeve 10, a snap ring 180 is arranged in a circumferential groove along the outer circumference region of sleeve 10 and is provided for receiving caps. The thickness of the groove or the snap ring is substantially 2 mm.

In the interior of sleeve 10, the ball clamping set 60 is arranged between the bush 20 and the plug 30. The design of the ball clamping set 60 is formed of a sequence of one first ball 80 as well as nine second balls 90, 95, the diameter of the first ball being 19 mm and the diameter of the second balls being 6 mm each. The second balls 90, 95 are arranged so as to minimize the volume between two successive first balls 80. The first ball 80 is in point-to-point contact with the further balls of the ball clamping set 60 so as to minimize friction. The second balls 90, 95 are also in point-to-point contact with one another and with the inner wall of sleeve 10. Eight ball clamping sets 60 are distributed over the length of the expansion region 40. The length of the expansion region 40 extends substantially along the longitudinal direction of sleeve 10 from the region of the bush 20 to the region of the plug 30. The conversion of the axial force which is applied by the bush 20 is described in more detail in FIG. 11.

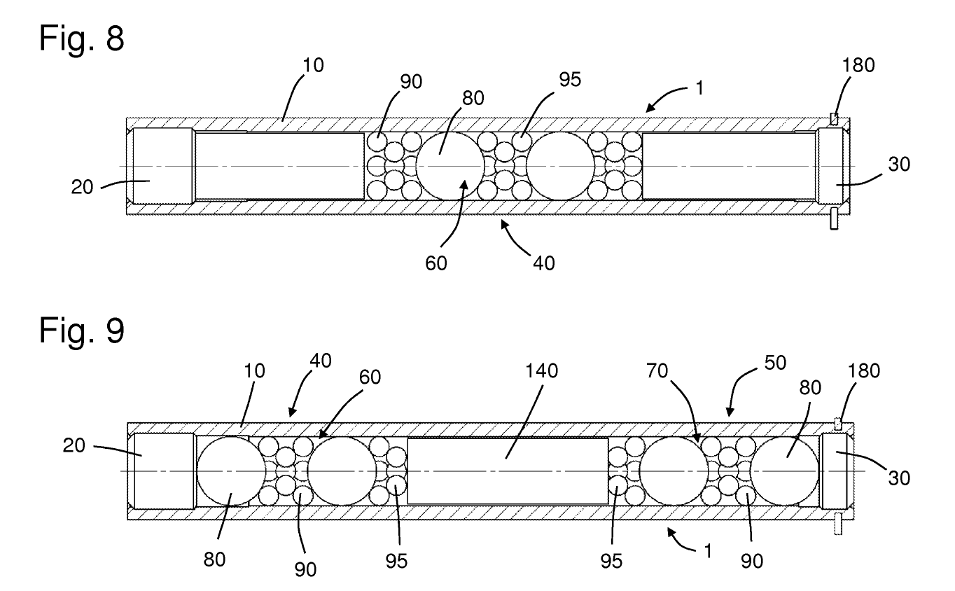

A second embodiment of the clamping device 1 according to the invention is now described with reference to FIG. 8, which is shown in a partial sectional view. The design of the ball clamping set 60 is identical with the above described first embodiment of the clamping device 1.

Bush 20 extends substantially from a longitudinal end of sleeve 10 into the interior of sleeve 10 up to a region which corresponds substantially to one third of the length of sleeve 10. In this arrangement, the region of the longitudinal end of bush 20 which faces the interior of sleeve 10 is designed as a cylinder. The plug 30 is arranged at the other longitudinal end of sleeve 10 and also extends into the interior of sleeve 10 up to a region which corresponds substantially to one third of the length of sleeve 10. Both the bush 20 and the plug 30 are connected with the ball clamping set 40 by means of second balls 90, 95. The length of the expansion region 40 thus extends substantially over one third of the length of sleeve 10, the expansion region 40 again being arranged in the central region of sleeve 10.

FIG. 9 shows a third embodiment of a clamping device 1 according to the invention. In contrast to the first embodiment according to FIG. 1, a bridging member 140 is here movably arranged in the central region of sleeve 10 in the interior thereof and is formed as a cylinder. The diameter of the bridging member 140 corresponds substantially to the inside diameter of sleeve 10. The bridging member 140 is here arranged between a first expansion region 40, where two ball clamping sets 60 are disposed, and a second expansion region 50 which also has two ball clamping sets 70. At its longitudinal end, which faces the interior of sleeve 10, plug 30 is formed along the lines of a calotte for receiving the first ball 80.

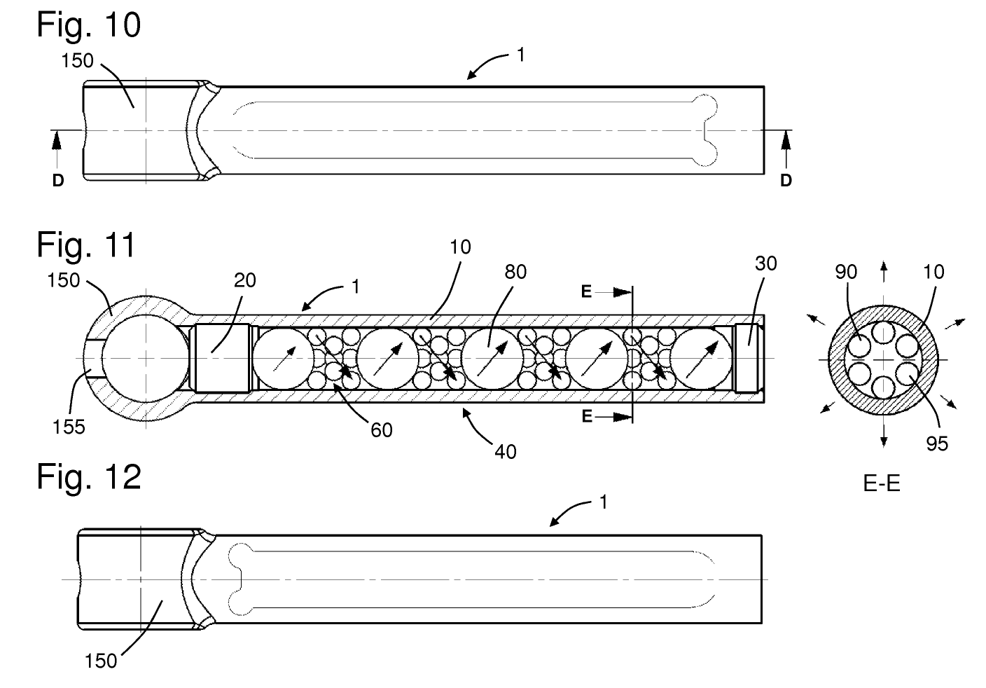

A fourth embodiment of a clamping device 1 according to the invention is now described with reference to FIGS. 10-12. At a longitudinal end, sleeve 10 is provided with a bush 150 which can receive a cylindrical tool. The longitudinal axis of bush 150 and the rotary axis of sleeve 10 intersect while being perpendicular to each other.

The central region of the free longitudinal end of bush 150 has a bore 155 which extends in the direction of sleeve 10. The diameter of bore 155 is chosen such that the bush 20 can be reached with a wrench through bore 155 so that the bush 20 can be screwed in or out.

FIG. 11 shows in a partial section along section line D-D an arrangement of bush 20 and plug 30 according to FIG. 1. A ball clamping set 60 is again arranged between bush 20 and plug 30. It consists of a plurality of first balls 80 and second balls 90, 95.

In the case of an axial force application, the bush 20 is screwed into the sleeve 10 so as to transmit this force via the interface with the ball clamping set 60, here the first ball 80, to the ball clamping set 60. The connection side of bush 20 with the ball clamping set 60 is designed along the lines of a calotte for receiving the first ball 80. The balls 80, 90, 95 of the ball clamping set 60 transmit the forces applied thereto to their particular contacting partners in the normal direction at the corresponding contact point so that the ball clamping set 60 can transmit both radial forces and axial forces to a surrounding structure. When an axial force is applied to the bush 10, this results in an axial clamping of the sleeve 10 owing to the non-movable plug 30 so that the sleeve is simultaneously lengthened and outwardly expanded in the radial direction.

The right-hand side of FIG. 11 shows a sectional view through the clamping device 1 along section line E-E. The second balls 90, 95 are here in point-to-point contact with one another and also in a point-to-point contact with the inner wall of sleeve 10 and the clamping tongues so that the axial force applied via bush 20 is converted via the ball clamping set 60 into a radial force which is shown by way of diagram using the arrows. The radial force is applied uniformly and continuously along the circumference of sleeve 10 and the clamping tongues, the number of the force application points of the ball clamping set 60 increasing with decreasing diameter of the second balls 90, 95 so as to achieve a particularly uniform force application which is again substantially free from friction.

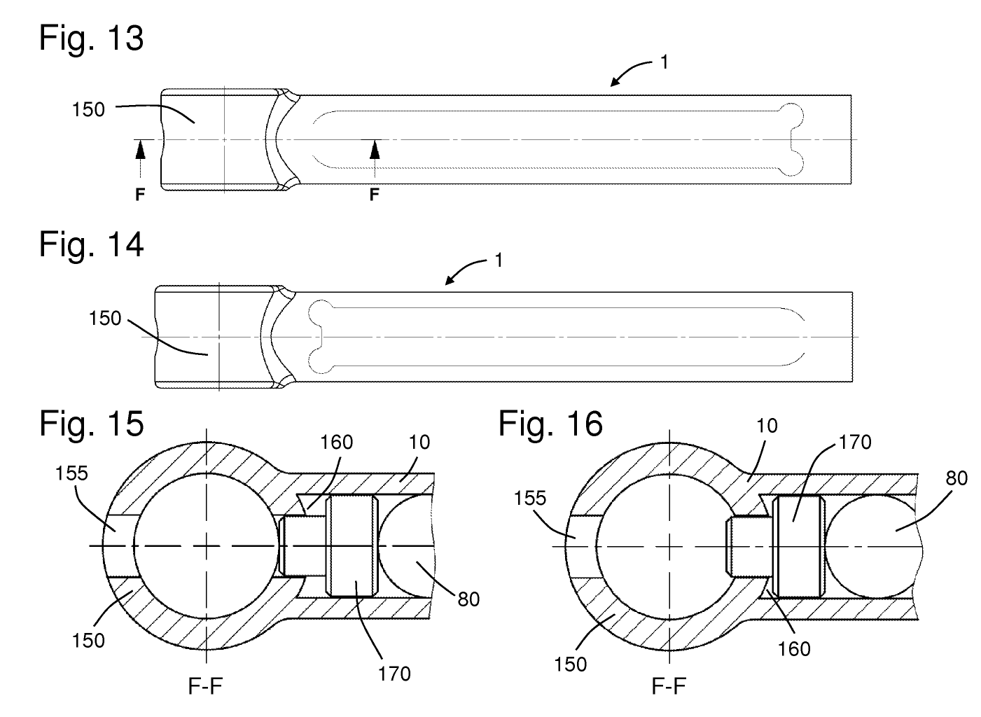

A fifth embodiment of a clamping device 1 according to the invention is now described with respect to FIGS. 13-16. In this arrangement, a longitudinal end of sleeve 10 again has a bush 150 for receiving a cylindrical workpiece (not shown). In contrast to the previous embodiment, a piston 170 is now arranged in the region of the bush 150 within sleeve 10, said piston being axially movable and cooperating with the ball clamping set. A stop 160 is formed at a longitudinal end of bush 150. It confines the movement of the piston 170 in an end position. The piston 170 here has a substantially cylindrical shape, a first cylindrical section having a diameter smaller than that of a second cylindrical section which is arranged towards the ball clamping set. The first cylindrical section of piston 170 cooperates with bush 150 through a bore in bush 150. The axial force is applied via a clamping bush (not shown) to the ball clamping set, the clamping bush being located at the longitudinal end, opposite the bush 150, of sleeve 10.

FIG. 15 shows in an enlarged sectional view along section line F-F the piston 170 in a retracted position or a starting position where the clamping bush does not apply an axial force to the clamping device 1. The (cylindrical) workpiece can now be introduced into the bush 150.

FIG. 16 shows in an enlarged sectional view along section line F-F the piston 170 in an extended position, the piston 170 not yet abutting against the stop 160. If an axial force is applied via the clamping bush, the ball clamping set applies an axial component thereof up to the piston 170 so that the latter is moved towards the bush 150 and is able to apply a force to the workpiece in the bush 150 and to clamp it therein. In order to return the piston 170 to its starting position, a spring (not shown) can be provided between piston 170 and stop 160.

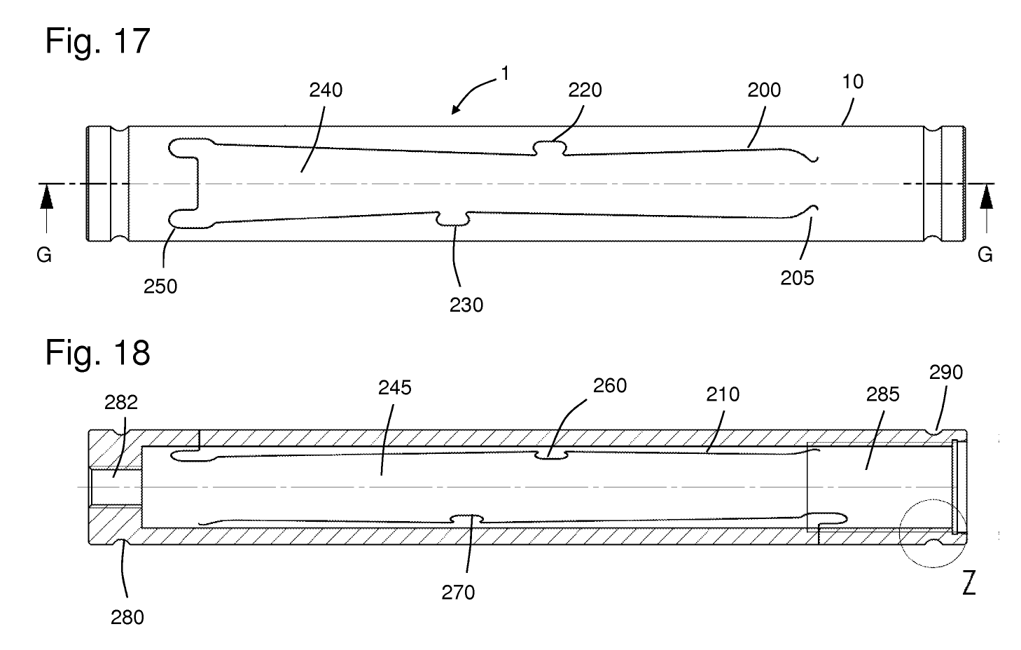

A sixth embodiment of a clamping device 1 according to the invention is now described with reference to FIGS. 17-20.

The sleeve 10 of clamping device 1 again has two clamping tongues 240, 245 which are arranged on opposite sides. The clamping tongues 240, 245 are limited by slots 200, 210 which were introduced into the wall of the sleeve 10 by means of laser machining. The clamping tongues 240, 245 and the sleeve 10 are connected with one another in each case in the region of a longitudinal end of clamping tongue 240, 245 by means of a bridge which realizes the function of a hinge and a spring element for the axial longitudinal compensation under load. The slots 200, 210 both have in this support region 205 a concave shape which takes care to prevent a crack formation and, resulting therefrom, a crack growth of slots 200, 210 into the region of the bridge or into the region outside the clamping tongues 240, 245 when a load is applied.

In the region of the other longitudinal end of clamping tongue 240, 245 one undercut region 250 each is formed in the sleeve 10 by the slots 200, 210. It receives a correspondingly formed counterpart of the clamping tongue 240, 245 so that a removal of the clamping tongue 240, 245 from the region 250 is not possible under load while the region of the clamping tongue 240, 245 can move in a radial direction under load. The undercut region 250 has a shape so as to form in its central region a curved rectangular area on which a circular region borders in each case. This arrangement of the undercut region 250 can reduce the tensions of the clamping tongues 240, 245 upon contact with the sleeve 10 under load.

The two clamping tongues 240, 245 are opposed, the geometries of the clamping tongues 240, 245 being oriented such that they are mirror-inverted relative to a point with respect to one another. The accompanying reflection point is located on the rotary axis of sleeve 10 and in the central region of clamping tongue 240, 245. Furthermore, the outlines of the individual slots 200, 210 and the individual clamping tongues 240, 245 are all mirror-symmetric relative to a plane which extends through the rotary axis of the sleeve 10.

In the area between the undercut region 250 and the support region 205, the slots 200, 210 have a shape tapering towards the rotary axis of the sleeve 10, a side of slot 200, 210 having a first limiting member 220, 270 and the opposite side of slot 200, 210 a second limiting member 230, 260. The inventive extension of slots 200, 210 towards the central region of clamping tongues 240, 245 takes care to compensate the cross-section of sleeve 10 in the circumferential direction along the longitudinal direction of sleeve 10 so as to considerably reduce tension peaks in the region of limiting members 220, 230, 260, 270 under load, which reduces the load and increases the lifetime of the clamping device.

The shape of the two limiting members 220, 230, 260, 270 of a clamping tongue 240, 245 is chosen such that a dovetail-like latch of limiting member 220, 230, 260, 270 with sleeve 10 occurs under load. The two limiting members 220, 230, 260, 270 of a clamping tongue 240, 245 are formed in the central region thereof, the limiting members 220, 230 260, 270 being spaced and staggered in opposite directions along the longitudinal axis of sleeve 10. The use of the limiting members 220, 230, 260, 270 can counteract a material fatigue of the clamping tongues 240, 245 during operation since they confine the radial expansion of the clamping tongues 240, 245 under load on account of the contact with the correspondingly shaped counter-region in sleeve 10 so as to always elastically deform the material.

The clamping tongues 240, 245 and the sleeve 10 are all made from the same material. In addition, the clamping tongues 240, 245 and the sleeve 10 are formed as one part.

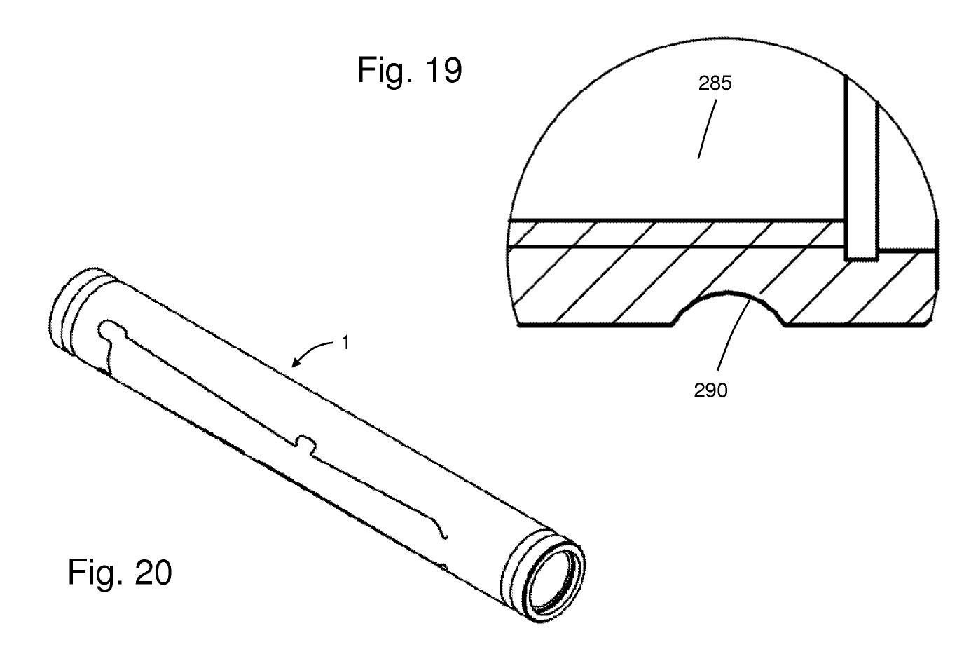

FIG. 18 shows a sectional view of the sixth embodiment of the clamping device according to FIG. 17 of the invention along section line G-G, the sleeve 10 having a first groove 280 in spaced-apart fashion from its longitudinal ends towards the center thereof and a second groove 290 on the opposite side. Furthermore, the sleeve 10 has in the region of one longitudinal end a screw thread 282 for screw fitting the clamping device 1 with an additional external component (not shown).

In addition, the interior of sleeve 10 has in the region of the longitudinal end opposite the screw thread 282 a screw-in region 285, its diameter being larger than the diameter of screw thread 282.

FIG. 19 shows an enlarged sectional view of the region Z of the clamping device comprising the screw-in region 285 and the second groove 290.

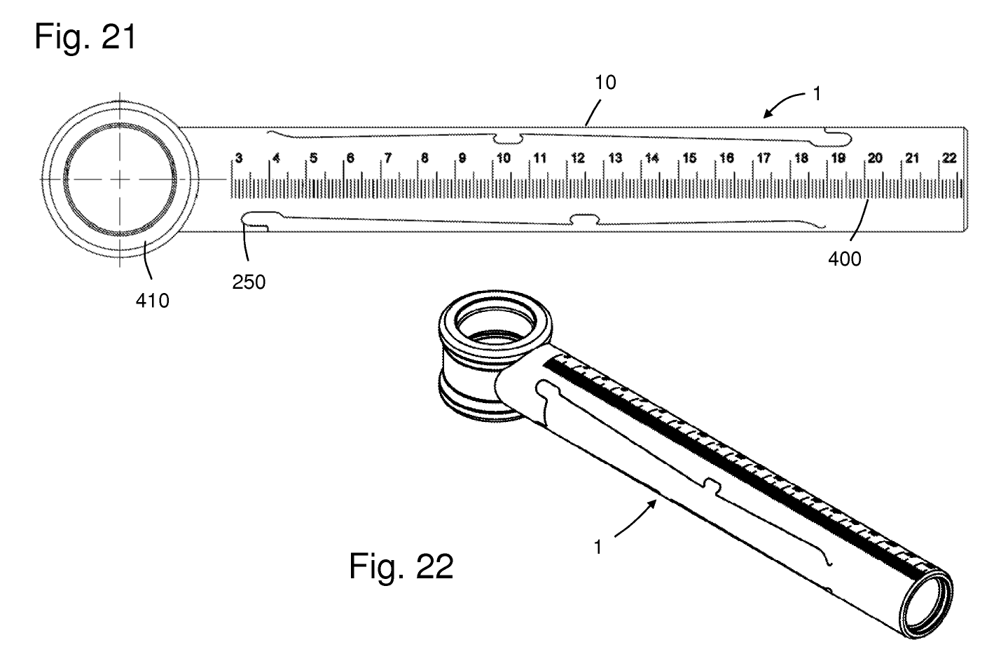

A seventh embodiment of the clamping device according to the present invention is now described with reference to FIG. 21 and FIG. 22. In addition to the features of the sixth embodiment of the clamping device, this device also has a measurement scale 400 at the sleeve 10 in the area of its outer circumference region. Furthermore, the measurement scale 400 extends from a longitudinal end to the opposite undercut region 250 along the longitudinal axis of sleeve 10. In addition, the sleeve 10 has another bush 410 in the region of a longitudinal end.

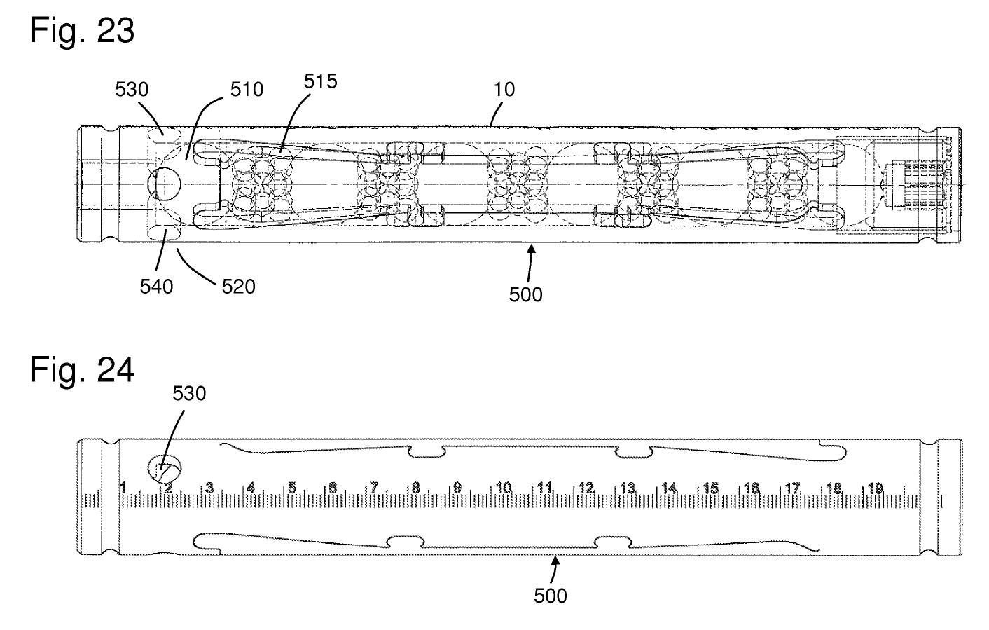

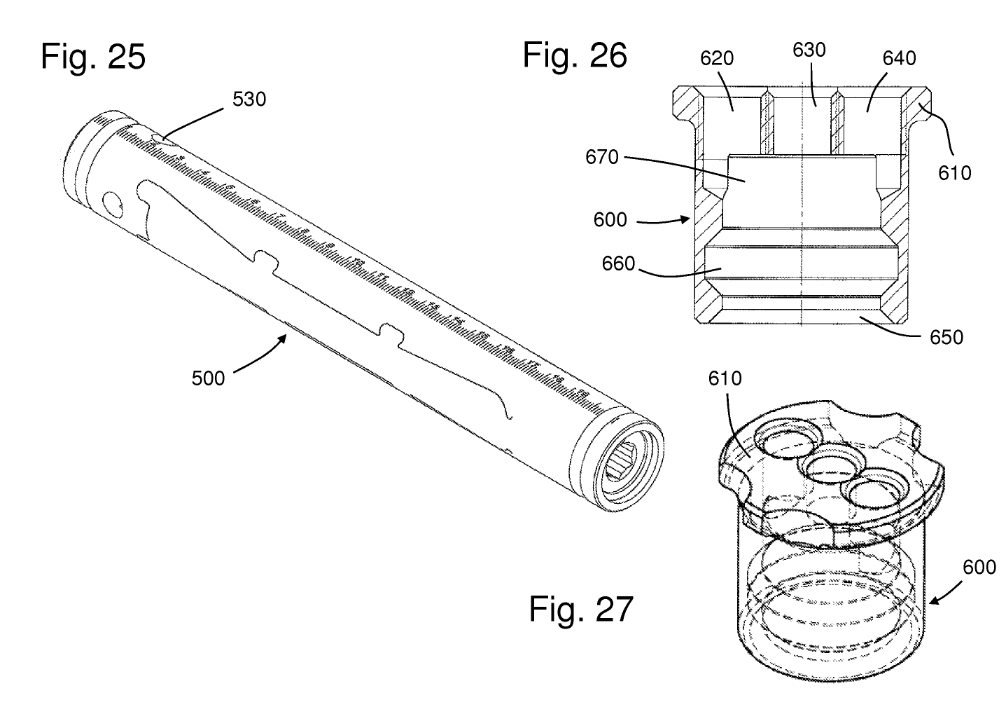

An eighth embodiment of the clamping device according to the present invention is now described with reference to FIGS. 23-25. In addition to the features of the sixth or seventh embodiments, this device also has a clamping mechanism for a bush (not shown).

In the region of a longitudinal end of the sleeve 10 of the clamping device 500 there is arranged a first ball 510 whose diameter is larger than the diameter of the second balls 515 of a ball clamping set. When the clamping device 500 is clamped, the first ball 510 moves in an axial direction of the sleeve 10 towards a bush clamping region 520. In the bush clamping region 520, a plurality of clamping ball supports 530, 540 are formed over the entire circumference of the sleeve 10 at regular intervals, which extend in the radial direction of the sleeve 10 and fully extend through the wall of the sleeve 10. Each clamping ball support 530, 540 serves for supporting a bush clamping ball (not shown), the bush clamping ball being movable along the accompanying clamping ball support 530, 540 in the interior thereof.

As soon as the first ball 510 is moved by the cooperation with the upstream clamping sets in the direction of the bush clamping region 520, it cooperates with the bush clamping balls, the bush clamping balls being moved along the accompanying clamping ball support 530, 540 towards the outer circumference region of sleeve 10. The shape of the clamping ball support 530, 540 is chosen such that, when in an end position, the bush clamping balls protrude up to a certain height from the outer circumference of sleeve 10 in a radial direction. In this end position, the bush clamping ball is prevented by a stop (not shown) in the clamping ball support 530, 540 from further moving in the radial direction.

FIGS. 26 and 27 show a multi-interface bush 600 for clamping with the clamping mechanism of the clamping device according to the eighth embodiment of the present invention. The multi-interface bush 600 has a substantially cylindrical shape, a flange 610 being formed at a longitudinal end thereof.

The longitudinal end of the multi-interface bush 600, which is opposite the flange 610, is provided with an introduction region 650 which in connection with an adjacently arranged connection region 660 has an undercut structure. The connection region 660 is formed in the interior of the multi interface bush 600, its design being chosen such that its central region has a disk-like shape and the diameter tapers towards the longitudinal ends. When the multi-interface bush 600 is connected with the clamping device, the bush clamping balls of the clamping device (not shown) are received by the wall of the connection region 660 and are in contact therewith, an axial movement of the multi-interface bush 600 being prevented via a positive connection between the bush clamping balls of the clamping device and the connection region 660.

A transitional region 670 borders on the connection region 660 in the interior of the multi-interface bush 660 towards the flange 610. It has a substantially cylindrical shape.

Three support openings 620, 630, 640 developed along the lines of a cylindrical bore are formed in the central region of flange 610 along a line through the longitudinal axis of the multi-interface bush 600 for the connection with further components (not shown) which extend up to the transitional region 670.

The embodiments shown are only illustrative and not limiting. Numerous modifications can be made therewith out leaving the scope of the claims. In addition, all features of the above described embodiments of the invention can be combined with one another in any way.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the claims, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1.-20. (canceled)

21. A clamping device comprising:
a support body including a clamping member for applying an axial force at a longitudinal end thereof, a limiting member substantially in the region of the opposite longitudinal end of the support body, and at least one expansion region; and
at least one ball clamping set arranged in the at least one expansion region, the at least one ball clamping set including a first ball having a first diameter and at least two second balls having a second diameter, the first diameter being larger than the second diameter and the at least one ball clamping set cooperating with the clamping member, wherein the balls of the at least one ball clamping set are in contact so as to convert the axial force of the clamping member by means of the at least one ball clamping set into a radial force which acts towards the support body.

22. The clamping device according to claim 21 wherein the support body is a sleeve.

23. The clamping device according to claim 21 wherein the support body has at least two slot-like recesses at its outer circumference region, the inner region of the at least two slot-like recesses forming a clamping tongue.

24. The clamping device according to claim 23 wherein the support body and the clamping tongues are formed as one parts.

25. The clamping device according to claim 23 wherein the support body has at least one undercut structure in the region of at least one clamping tongue.

26. The clamping device according to claim 25 wherein a movement of a longitudinal end of at least one clamping tongue is confined by the undercut structure of the support body in the region of at least one clamping tongue.

27. The clamping device according to claim 22 wherein the clamping member is a first bushing including a screw thread for screw fitting in the sleeve having a correspondingly formed internal screw thread.

28. The clamping device according to claim 21 wherein the limiting member is movable.

29. The clamping device according to claim 21 wherein the limiting member is a second bushing having a screw thread for screw fitting in the support body.

30. The clamping device according to claim 21 wherein the clamping device is a power amplifier.

31. The clamping device according to claim 21 wherein the bending stiffness of the support body is increased in the clamped state as compared to the unclamped state.

32. The clamping device according to claim 21 wherein the at least two slot-like recesses are directed in a radial direction to the central axis of the sleeve.

33. The clamping device according to claim 21 wherein adjoining expansion regions are connected by means of at least one bridging member.

34. The clamping device according to claim 21 wherein a bushing for receiving a workpiece is formed at a longitudinal end of sleeve.

35. The clamping device according to claim 23 wherein a longitudinal end of at least one clamping tongue realizes the function of a hinge.

36. The clamping device according to claim 23 wherein at least one clamping tongue is formed by a single slot.

37. The clamping device according to claim 23 wherein the support body and the clamping tongues are formed of the same material.

38. The clamping device according to claim 21 wherein the at least one ball clamping set cooperates with a force transmission member, the force transmission member being movably supported in the support body.

39. A clamping device comprising:
a support body including a clamping member for generating an axial force at a longitudinal end thereof, a limiting member substantially in the region of the opposite longitudinal end of the support body, and at least one expansion region, wherein the support body is a sleeve having at least two slot-like recesses at its outer circumference region, the inner region of the at least two slot-like recesses forming a clamping tongue; and
at least one ball clamping set arranged in the at least one expansion region, the at least one ball clamping set including at least one first ball having a first diameter and at least two second balls having a second diameter, the first diameter being larger than the second diameter and the at least one ball clamping set cooperating with the clamping member, the balls of the at least one ball clamping set being in contact so as to convert the axial force of the clamping member by means of the at least one ball clamping set in a substantially friction-free fashion into a radial force acting towards the outside of the support body.

40. A clamping device comprising:
a support body having a clamping member for generating an axial force at a longitudinal end thereof, a limiting member substantially in the region of the opposite longitudinal end of the support body, and at least one expansion region, wherein the support body is a sleeve having at least two slot-like recesses at its outer circumference region, the inner region of the at least two slot-like recesses forming a clamping tongue, and wherein the support body and the clamping tongues form one part; and
at least one ball clamping set arranged in the at least one expansion region, the at least one ball clamping set including at least one first ball having a first diameter and at least two second balls having a second diameter, the first diameter being larger than the second diameter and the at least one ball clamping set cooperating with the clamping member, wherein the balls of the at least one ball clamping set are in contact so as to convert the axial force of the clamping member by means of the at least one ball clamping set in a substantially friction-free manner into a radial force which acts towards the outside of the support body.
